(19) United States
(12) Patent Application Publication
(10) Pub. No.: US 2025/0004164 A1
(43) Pub. Date: Jan. 2, 2025

(54) METEOROLOGICAL EVENT DETECTION USING GRADIENT DESCENT METHOD

(71) Applicant: OTT HYDROMET CORP., Sterling, VA (US)

(72) Inventors: Christopher R. BENESCH, Colorado Springs, CO (US); Robert SCHEINHARTZ, Lone Tree, CO (US)

(73) Assignee: OTT HYDROMET CORP., Sterling, VA (US)

(21) Appl. No.: 18/216,754

(22) Filed: Jun. 30, 2023

(51) Int. Cl. G01W 1/02

(52) U.S. Cl. CPC G01W 1/02

(57) ABSTRACT

A meteorological event detection method provides a distribution of a plurality of data points, each having a geographical position and a property value, and each corresponding to a particle that has a first position corresponding to the geographical position and is moveable within the distribution. For each particle, a velocity vector is assigned based on the property values of surrounding data points, and an updated position is assigned to the particle based on the first position and the velocity vector. It is determined whether each particle satisfies an escape condition, wherein the escape condition is set based on a predetermined threshold spatial size within the distribution. Plural final property values are determined based on the updated position of at least one particle that is determined to satisfy the escape condition. A meteorological event is detected based on the plurality of the final property values.

### BACKGROUND

The accurate detection of meteorological events is critical across a variety of industries. Weather forecasting continuously relies on the precise detection and depiction of meteorological phenomena, and this detection and depiction are used not only to provide useful information for analysis, but also to improve the safety and structural integrity of vehicles and infrastructure.

One example of detecting these meteorological events is the identification of high and low pressure zones. Accurately detecting and visualizing pressure zones is crucial for predicting meteorological changes, such as inclement weather. Another example of detecting these meteorological events is jet stream identification. Accurately detecting and visualizing jet streams is crucial for the aviation industry, for example, because pilots and air traffic controllers rely on this information to ensure the safe and orderly flow of air traffic across the globe. Although conceptually the identification of a jet stream appears to simply require finding the axis of maximum wind speed, in actuality the process is complex due in part to the existence of multiple jet streams running parallel, merging, or splitting into different axes.

Conventionally, there have been both manual and automated methods of meteorological event detection. Although recent methods have brought improvements in accuracy, there is still a great need for improvement. For identifying the high and low pressure zones, conventional techniques fail to accurately identify the most significant pressure positions. In particular, conventional methods are inefficient and also incomplete because they focus only on extrema and fail to give consideration to the significant values that are not located at the extrema.

For identifying jet streams, conventional methods suffer from a lack of efficiency due to requiring excessive time for drawing and labeling jet stream maximum. This inefficiency leaves less time for meteorologists to analyze, forecast and add value to events of, for example, turbulence and convection. In addition, recent automated jet stream identification tools utilize algorithms that identify jet streams by identifying points of extrema and connecting those points to draw the jet streams. However, because these conventional methods do not take into account the direction and other physical properties of the wind at each position, the resulting depiction of the jet stream fails to truly follow the actual jet stream and as a result has a jagged appearance with sudden changes of direction; this jagged appearance diminishes the effectiveness of the jet stream detection and depiction on, for example, a map display.

The inventors of this application discovered that the conventional detection of meteorological events can be greatly improved by applying the principles of gradient descent to increase the detection accuracy.

### SUMMARY

One object of the present disclosure is to provide a highly accurate method for meteorological event detection using gradient descent principles to overcome the above inefficiencies of conventional methods. By employing the principles of gradient descent, the method disclosed herein identifies meteorological events in an iterative manner to locate the most significant event data.

According to one aspect, the disclosure provides a meteorological event detection method. The method provides a distribution of a plurality of data points based on meteorological data, each data point having at least (i) a geographical position, and (ii) a property value that relates to a meteorological condition, and each data point corresponding to a particle that has a first position corresponding to the geographical position and is moveable within the distribution. For each particle, a velocity vector is assigned based on the property values of surrounding data points. For each particle, an updated position is assigned to the particle based on the first position and the velocity vector. Then for each particle, it is determined whether the particle satisfies an escape condition by determining whether movement of the particle is bounded within a space that satisfies the escape condition, wherein the escape condition is set based on a predetermined threshold spatial size within the distribution. A plurality of final property values are determined, wherein each final property value relates to the meteorological condition and is determined based on the updated position of at least one particle that is determined to satisfy the escape condition. A meteorological event is detected based on the plurality of the final property values.

According to another aspect, the disclosure provides an information processing apparatus for meteorological event detection. The information processing apparatus includes a memory and a processor. The processor provides a distribution of a plurality of data points based on meteorological data, each data point having at least (i) a geographical position, and (ii) a property value that relates to a meteorological condition, and each data point corresponding to a particle that has a first position corresponding to the geographical position and is moveable within the distribution. For each particle, a velocity vector is assigned by the processor based on the property values of surrounding data points. For each particle, an updated position is assigned by the processor to the particle based on the first position and the velocity vector. Then for each particle, it is determined by the processor whether the particle satisfies an escape condition by determining whether movement of the particle is bounded within a space that satisfies the escape condition, wherein the escape condition is set based on a predetermined threshold spatial size within the distribution. A plurality of final property values are determined by the processor, wherein each final property value relates to the meteorological condition and is determined based on the updated position of at least one particle that is determined to satisfy the escape condition. A meteorological event is detected by the processor based on the plurality of the final property values.

### BRIEF DESCRIPTION OF THE DRAWINGS

FIG. 1 is a block diagram of an information processing apparatus for meteorological event detection according to an embodiment.

FIG. 2 is a flowchart showing a meteorological event detection method according to an embodiment.

FIG. 3 is an explanatory diagram of the contents of each particle used in the meteorological event detection method according to one embodiment.

FIG. 4 is a diagram of a gradient descent run across fifty iterations.

FIG. 5 is an image of an example of a display output based on the results of the meteorological event detection method.

FIG. 6 is an image of another example of a display output based on the results of the meteorological event detection method.

### DETAILED DESCRIPTION OF EMBODIMENTS

In the following description, numerous details are set forth to provide an understanding of the present disclosure. However, it is understood by those skilled in the art that the systems and methods of the present disclosure may be practiced without these details and that numerous variations or modifications from the described embodiments may be possible.

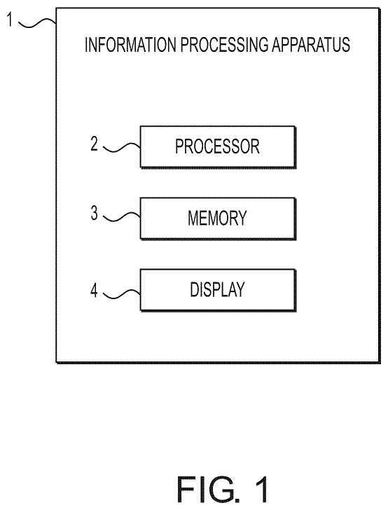

Embodiments of the present disclosure provide a method and system for meteorological event detection using gradient descent principles. Although the features of this disclosure can be applied to detect many different meteorological events, the exemplary embodiments will focus on the identification of jet streams and the detection of high and low pressure zones. The principles of gradient descent facilitate an iterative detection of jet streams and high and low pressure zones that identifies the most significant event data. In addition to finding the highest and lowest (extrema) event values, the disclosed method identifies significant values near the extrema. Such significant values have been overlooked in the conventional methods. Using the detected significant values, the method then outputs data for depicting the meteorological events. These and other features are described in detail below in connection with FIGS. 1-6.

Gradient descent is a known iterative mathematical process to determine certain properties of data which could not be determined using standard algorithms. The iterative algorithm of gradient descent is used to find a local minimum of a differentiable function. For each data point that is not at a local minimum, the data point is adjusted (e.g., by adjusting the weight or bias applied to the data point) repeatedly to take “steps” in the direction opposite the gradient, to eventually reach the local minimum of the function (or local maximum, in the case of gradient ascent). Because the principles of gradient descent are well-known, no further explanation will be provided.

As used herein, the term “gradient descent” will refer to both gradient descent and gradient ascent. In particular, exemplary embodiments will identify jet streams by finding the highest wind velocity points, which are near or at a local maximum found using gradient ascent principles. In addition, exemplary embodiments will identify data points near or at the local maxima of pressure for high pressure zones (using gradient ascent principles) and the local minima of pressure for low pressure zones (using gradient descent principles). But for the sake of simplicity, the discussion will refer to gradient descent and minima in each case.

As used herein, the term “particle” will be used to refer to a particular data point or a particular data value. The data points may be acquired from any of a number of global forecast systems. For example, real-time meteorological data may be acquired from the World Area Forecast Centre, the National Centers for Environmental Prediction (NCEP), the European Centre for Medium-Range Weather Forecasts (ECMWF), and other similar providers of meteorological data. For identifying jet streams, the acquired data will be multi-dimensional values of wind velocity (wind speed) each having a velocity value and an associated position and direction of travel. The units of measurement for the values of wind velocity may be meters per second or miles per hour, and are derived from two parameters representing north/south and east/west magnitudes of wind motion. For detecting high and low pressure zones, the acquired data will be multi-dimensional values of pressure each having a pressure value and an associated geographic position value. The units of measurement for the values of pressure may be millibars (mb) or pascals (Pa). The data for each particle can correspond to values that are directly measured by sensors, or from values that are forecast or interpolated.

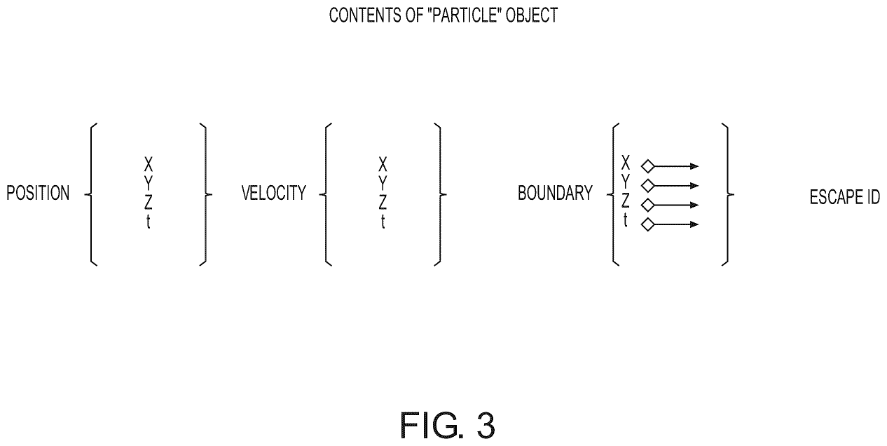

As shown in FIG. 3, during the iterative gradient descent process discussed below, each particle will have a corresponding position value and velocity value in multiple dimensions. As explained below, the boundary positions of each particle will be updated until an escape condition is met, where the particle is given an “escape ID” according to its respective escape region.

Referring to FIG. 1, the system for meteorological event detection using gradient descent principles includes an information processing apparatus 1 for executing the methods described in detail below. The information processing apparatus 1 can include a processor 2, a memory 3 and a display 4. The memory 3 stores information (for example, programs and various data), and the processor 2 functions based on the information stored in the memory 3. The functions of the processor 2 may be realized by individual hardware, or may be realized by integrated hardware. Also, the processor 2, the memory 3, and the display 4 may be integrated in the information processing apparatus 1, as shown in FIG. 1. Alternatively, the processor 2, the memory 3, and the display 4 may be partially or completely remotely arranged with respect to each other. For example, the display 4 may be remotely located and connected to the processor 2 via a network (not shown). The network may include a wireless communication network, the Internet, a VPN (Virtual Private Network), a WAN (Wide Area Network), a wired network, or any combination of these, or the like.

The processor 2 may be, for example, a central processing unit (CPU). However, the processor 2 is not limited to a CPU, and various processors such as a graphics processing unit (GPU) or a digital signal processor (DSP) can be used. The processor 2 may be a hardware circuit based on an ASIC. The term “processor” encompasses both a single processor and multiple processors.

The memory 3 may be a semiconductor memory such as a static random access memory (SRAM) or a dynamic random access memory (DRAM), a register, a magnetic storage device such as a hard disk device, or an optical storage device such as an optical disk device. For example, the memory 3 stores computer readable instructions, and the processor 2 executes the instructions to realize the function of each part of the system and method. The instructions here may be instructions constituting the program or instructions for the hardware circuit of the processor 2 to perform the method.

The display 4 includes a display device such as a liquid crystal display or an organic EL (electro-luminescent) display. The display 4 can display various images. The display 4 is constituted by, for example, a computer screen, and functions to display data output by the processor 2. The processor 2 may cause the display 4 to output information including display images. Alternatively, the processor 2 may transmit data to another processor which in turn causes the display 4 to output the information including the display images.

The information processing apparatus 1 executes methods for meteorological event detection using gradient descent principles. The features of this disclosure can be applied to detect many different meteorological events, in particular meteorological events that can be characterized by maximum or minimum values. The following exemplary embodiments describe the application of these features to the detection of high and low pressure zones and the identification of jet streams.

### (1) Pressure Zone Detection

The methods of this disclosure may be employed to detect meteorological phenomena including high and low pressure zones. To resolve the aforementioned deficiencies of conventional methods, the exemplary embodiments of this application apply the principles of gradient descent to identify the most significant pressure values. The principles of gradient descent are used to identify not only the highest and lowest pressure values, but also significant values near the extrema. In this way, the disclosed system and method provide a weighted representation of pressure values.

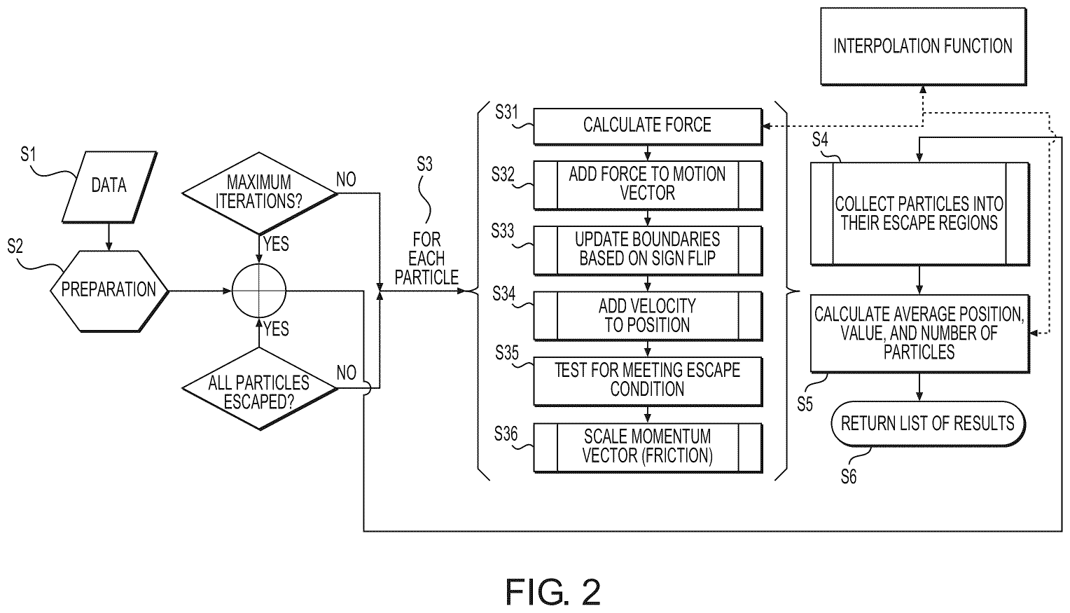

One method for detecting pressure zones using gradient descent principles may be understood with reference to FIG. 2. First, the processor 2 acquires the data of the particles from a global forecast system (step S1). Here, the particles each have a pressure value and a position value. For example, the data may be acquired as a grid of pressure values at sea level across the entire surface of the Earth, or across a particular region of the Earth's surface.

Next, in step S2, the acquired data is prepared for the gradient descent method by organizing the particles according to their position, thereby generating a distribution of particles for use in the method. The data is prepared for the gradient descent method by organizing the particles at regularly spaced intervals, thereby generating a distribution of particles for use in the method. As an example, the data points (particles) may be distributed across the grid with ¼ degree between each particle; this corresponds to approximately 111 km per degree of latitude (or about 28 km between points across the entire surface of the Earth). At this step, all of the data points are used in the distribution, and no interpolation is required.

Also at step S2, the particle distribution (grid) is divided equally by a threshold region size (e.g., ¼ grid) to obtain consecutive escape regions across the entire grid. This will be described in greater detail below with respect to step S4.

Next, each particle is put through an iterative process using gradient descent principles to detect the local maximum and minimum pressure values as well as significant values of pressure within a threshold region described below (step S3). The term “significant” is used herein to refer to values having a weight (i.e., prevalence; frequency) greater than a threshold weight. In other words, a value that is detected a certain number of times for the particles within the threshold region is a significant value that will be used to detect the pressure zones and create the pressure zone depiction.

The iterative process of step S3 using gradient descent principles is performed for each particle of the data set according to the following sub-steps.

In step S31, for each particle a force (velocity) to be applied is calculated. As one example, a first particle has an initial position value and an initial pressure (property) value. Taking the four points surrounding the first particle in the distribution (the points positioned nearest to the first particle to the left, right, top and bottom), the distance from each surrounding particle as well as the x- and y-direction offsets from each surrounding particle are calculated. Using the hypotenuse of the triangle between the first particle and each surrounding particle, the x and y components are calculated and normalized (to be between 0 and 1). As shown in FIG. 2, an interpolation function is applied in step S31 to find the value at the x and y coordinates for each particle because not all of the particles will be on a grid point of the distribution data. The best results can be realized by an interpolation function that is smooth in nature as opposed to a linear translation; such functions can be, for example, Spatial Splines, Cressman, or Kriging.

The pressure of the first particle is then compared to the pressure of each surrounding particle. For example, if the pressure of the first particle is 1000 mb and the pressure of a second surrounding particle is 1002 mb, the x and y components of the first particle will be multiplied by the difference (i.e., by 2) to obtain a vector of momentum. When identifying a low pressure zone, the x and y components of the first particle will be multiplied by −2 in this example, such that the first particle is biased to move away from the higher pressure second particle; whereas for a high pressure zone, the x and y components of the first particle will be multiplied by +2 such that the first particle is biased to move toward the higher pressure second particle. This process is repeated with respect to all four surrounding particles. The vectors of momentum with respect to all four surrounding particles are added together to obtain a velocity vector (force) to add to the first particle to cause the first particle to move within the distribution. The particle will thus have an internal velocity including a velocity longitude (the x component) and a velocity latitude (the y component).

In step S32, this force is then added to the velocity vector of the first particle (Equation (1)). Initially, the particle will have no velocity vector because it will not be moving within the distribution. By adding this force to the particle, a velocity vector is created by which the particle moves toward the high or low pressure points, depending on whether the detection is for a high or low pressure zone. However, with subsequent iterations of step S3 of the disclosed method, this force will be newly calculated and added to the existing velocity vector, as described further below.

$$\vec{V} = \vec{V} + F ( magnitude ( \vec{V} ) , I ) \qquad Equation ( 1 )$$

In step S33, it is determined whether or not the sign of the velocity vector of the particle in question has changed (“flipped”) from positive to negative or from negative to positive; and, if the sign has flipped, the boundaries of a boundary region are set or updated at the position of the sign flip. As discussed above, by adding a velocity (force) vector to each particle, the particle is caused to move along the distribution in either a positive direction or a negative direction. For example, if the force added to the particle is negative in the X direction (i.e., the particle is moving right to left) and the previous velocity vector of that particle was positive (i.e., the particle was moving left to right), this indicates that the sign of the velocity has flipped at the current position of the particle. This position then serves as a boundary position of the particle. The boundary region (i.e., the region defined by the boundary positions) is set and updated separately for each individual particle. Because, as discussed above, the initial value of the particle has no velocity, updating of the boundary position is only considered for second and subsequent iterations of step S3. Also, if the sign of the velocity of the particle has not flipped, the boundary is not updated.

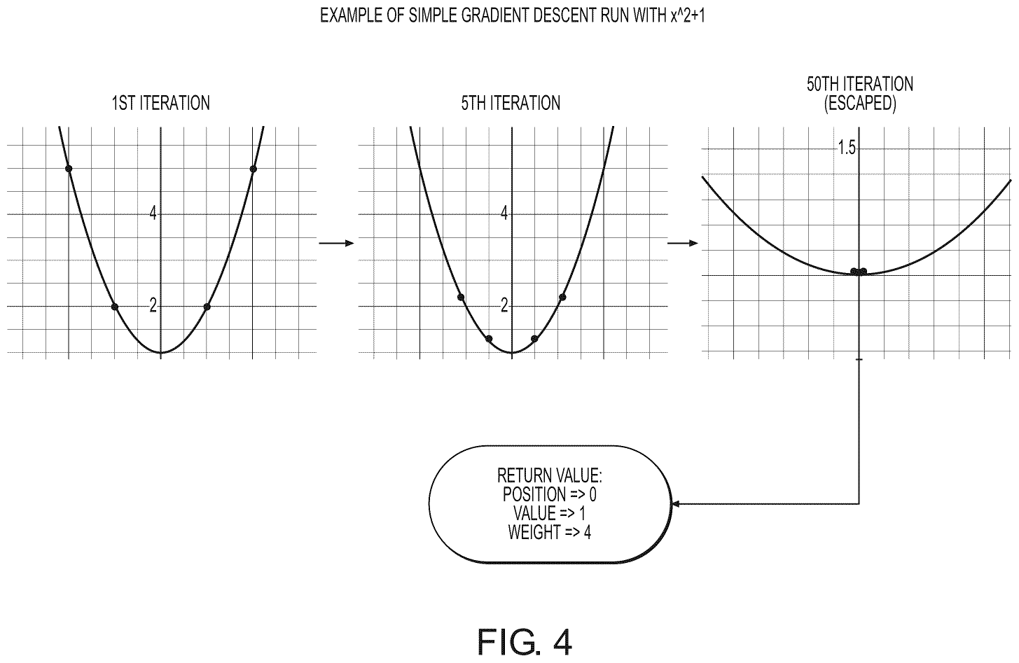

For purposes of explanation, each particle can be understood as moving along a curve, where the valley of the curve is the local minimum (or local maximum). An example of a simplified curve having a quadratic function is shown in FIG. 4, showing a gradient descent run for a function of x²+1. The y-axis of the curve may represent the pressure values, and the x-axis may represent the position values within the distribution (which, in turn, correspond to geographic positions in real space). Each time step S32 is performed for a particle in an iteration, the velocity vector of the particle is adjusted and, if that adjustment causes the particle's direction to change (i.e., causes the particle's sign to flip), a boundary position of that particle on the curve is updated to the position at which the sign flips. The position is the current position of the particle at step S3. As will be discussed further below, with more iterations of the gradient descent process, the boundary region of each particle will be adjusted to become smaller if the particle approaches lower values which may represent a local minimum.

Taking the first iteration shown in FIG. 4 as an example, assuming the boundary region for a particular particle is set as extending between the two upper particles on the curve (i.e., the two upper particles on the curve are the boundary positions for that particular particle), if by the fifth iteration the sign of the velocity vector has flipped twice, once each at the positions of the two upper particles shown on the curve in the fifth iteration, the boundary region has been updated to be at the positions of the two upper particles shown on the fifth iteration curve. More specifically, if the sign flips on one side of the curve in the second, third or fourth iteration and then flips again on the other side of the curve in the fifth iteration, the boundary positions become the positions of the two upper particles shown on the fifth iteration curve. In this manner, the boundary region gradually reduces in size as the particular particle approach the local minimum.

In step S34, the velocity of the particle is added to the position (Equation (2)). In other words, after the velocity (force) is calculated, the position value of the particle is updated based on the position to which the particle moves due to the added velocity. As noted in the preceding paragraph, if the sign flips, this new position represents the updated boundary region.

$$\vec{P} = \vec{P} + \vec{V} \qquad Equation ( 2 )$$

Next, in step S35, each particle is tested to determine whether it meets an escape condition (an example of a first condition). The phrase “escape condition” refers to a condition in which the updated boundary positions of the particle are at or within a threshold region. The “threshold region” is set in advance and represents a predetermined distance (i.e., predetermined threshold spatial size) within the distribution (e.g., a predetermined distance along the curve shown in FIG. 4). Although the actual positions of the threshold region are not known or set in advance (i.e., the iterative gradient descent process allows the actual positions to be discovered), the desired predetermined distance is set in advance. This dimension of the threshold region is determined and set in advance as a distance that is small enough that the particle will be significant and therefore probative of the meteorological event determination. In other words, once the two boundary positions of a particle are equal to or less than the predetermined distance that defines the threshold region, the escape condition is determined to be met for that particle. The threshold region may be set, for example, to be equal to half of the grid intervals of the particle distribution. Thus, if the grid is a ½ degree grid, the threshold region may be set to be ¼ degree. In this case, if the boundary positions of the particle are separated by ¼ degree or less, the particle is determined to have met the escape condition. However, this is only one example, and the threshold region's dimension may be set as appropriate based on the particle distribution and the desired level of significance. In other words, the threshold region can be set more narrowly or widely as desired to find values of varying significance.

If the escape condition is determined to be met for a particular particle, step S3 ends for that particle, and the process bypasses step S36 and proceeds directly to step S4. If, on the other hand, the escape condition is determined not to be met for the particle, the process proceeds to step S36. In step S36, the velocity vector of the particle is multiplied by a scalar component of friction (Equation (3)). The friction component “fr” is a real number between zero and one, but usually very close to one. The application of the friction component causes the particle's velocity to slow but not fully stop. After step S36, the process returns to step S31 to repeat the iterative gradient descent loop, beginning with calculating a new force to add to the current velocity vector of the particle. For each particle that does not meet the escape condition in step S35, the iterative gradient descent loop of steps S31 to S36 is repeated until all particles satisfy the escape condition, or until a maximum number of iterations has been performed. The maximum number of iterations could be in the thousands. The example shown in FIG. 4 indicates a particle satisfying the escape condition at the fiftieth iteration, but the required number of iterations could be in the hundreds or the thousands. As shown in FIG. 4, as the process moves from the first iteration, to the fifth iteration, and then to the fiftieth iteration, the distance between the boundary positions of the particle moves closer and closer to the threshold region's distance until it meets the escape condition.

$$\vec{V} = \vec{V} * fr \qquad Equation ( 3 )$$

Next, in step S4, the escaped particles (i.e., particles satisfying the escape condition) are collected and organized into a plurality of escape regions (groups). Here, the “escape regions” are the actual geographical regions on the particle distribution grid. The escape regions are equal in size to the predetermined threshold regions and are determined in advance. Specifically, when the data is prepared in step S2, the particle distribution (grid) is divided equally by the threshold region size (e.g., ¼ grid) to obtain consecutive escape regions across the entire grid. In addition, the position at which the particle is determined to have escaped is the position at which the boundary position of the particle is updated at the time the particle's boundary region meets the escape condition (i.e., is equal to or less than the threshold region distance). Thus, each particle is collected and organized into the escape region corresponding to the position at which the particle escaped. Even if two particles escape at different positions, they will be collected into the same escape region if those two positions fall within a single escape region.

After that, in step S5, for each escape region, the average position, the pressure value, and the number of particles are calculated. Specifically, for each escape region, the positions of all of the particles collected into that escape region are averaged to obtain the average geographic position. Then, in order to determine the pressure value representative of that escape region, interpolation is used to find the actual pressure value at the average position value. The pressure value corresponding to that actual point is taken as the pressure value of that escape region. Stated otherwise, the initial data distribution is referenced to find the pressure value at the calculated average position. In this way, the average position value and the corresponding pressure value are obtained for the escape region.

Finally, the number of particles in each escape region is calculated. The number of particles having a certain pressure value indicates the significance (weight) of that pressure value. Thus, by indicating the number of particles for each pressure value, the output data provides a weighted representation showing the significance of each pressure value.

In step S6, the list of results is output. This list of results includes the pressure values of each escape region as well as the associated number of particles (i.e., weight; significance) for each pressure value. The results may be output as formatted data sets or as map data for display on the display 4.

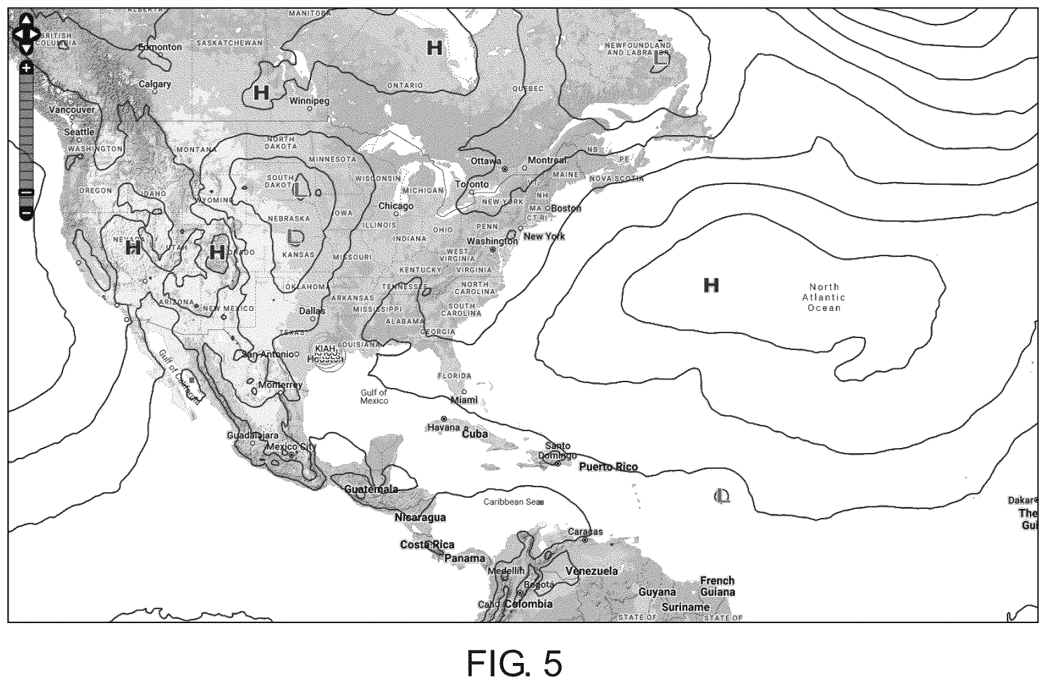

FIG. 5 shows an example of a map display depicting the identified pressure zones. Using a predetermined top percentage (i.e., threshold weight) of the most significant pressure values, the low and high pressure zones are determined by the collections of escape regions and their relative importance, allowing one to highlight important areas as opposed to regional instabilities. The map may be colored to indicate high and low pressure zones. Using the gradient descent method of this embodiment, the high and low pressure zones are automatically determined and depicted on the map.

The formatted data set may include the geographical position value, the pressure value, and the weight (number of particles) of that pressure value. As one non-limiting example, for a data distribution of 250,000 particles, the above method was applied with 512 iterations over a runtime of around 18 seconds on a mid-range home PC. The formatted data set showed the weight (i.e., number of particles), pressure value, and position for the top 96 escape regions (i.e., the 96 escape regions having the highest weight values).

In the formatted data set, by providing the weighted representation of the number of particles for each pressure value, differences in significance (i.e., weight; prevalence) may be easily understood, with the pressure values of escape regions having the higher number of particles being the more significant pressure values. Advantageously, a significance threshold (i.e., threshold weight) can be set as desired such that, for example, only the top 30% of prominent pressure values are considered when determining and depicting the high and low pressure zones. This significance threshold can be reduced to, for example, 20% or 10% to further refine the results to include only pressure values from escape regions having the highest numbers of particles.

With this meteorological event detection system and method, the processor 2 more accurately detects and identifies significant pressure values as compared to conventional methods that did not use the principles of gradient descent. Specifically, conventional methods that did not use gradient descent principles did not consider the significance of particle values according to the number of particles in escape regions as described above. Instead, conventional methods identified pressure particles based on the extrema values, and the accuracy was diminished by not considering significance among values. By identifying the most prevalent pressure values in a particular escape region, the disclosed system and method ensure that the significance of the various pressure values is determined and used to detect and depict the high and low pressure zones. As a result, the pressure zone identification is more accurate. In this way, the disclosed system and method provide an improvement over conventional processors that were not able to apply gradient descent principles to arrive at more accurate depictions of pressure zones.

Moreover, the use of gradient descent principles in identifying the pressure zones avoids the “false vacuum” problem. In particular, when a local minimum is incorrectly identified as a global minimum, that local minimum is a false vacuum because the true vacuum is located at the global minimum. By applying the principles of gradient descent to iteratively analyze the movement of particles, the disclosed method ensures that the true vacuum is identified, and thus the true maximum pressure values may be identified. Moreover, instead of basing the results on just a numerically smaller or larger value which may be isolated to a small geographical area, detecting and outputting the pressure zones based on the relative significance of the pressure values will more accurately detect pressure for larger pronounced areas which will have a greater impact on a wider region.

The disclosed method lends itself well to parallel processing with tools like OpenMP, OpenCL, or other parallel computing solutions. Although each iteration in step S3 is dependent on the last iteration, the particles themselves are not dependent on each other and can be processed simultaneously in each iteration. In other words, the disclosed method enables the processor to detect the meteorological event at a higher processing speed than in conventional methods because the disclosed method allows for all particles to be simultaneously processed in each iteration.

In addition, because the disclosed method avoids the use of complex “trig” functions which conventional methods relied upon, improved processing speeds can be achieved for the processor by the disclosed method. Note that “trig” functions in programming refer to any mathematical function that is not inherent in the ALU, for instance square root, pow( ), logarithm, sin, cos, tan, etc.

### (2) Jet Stream Identification

The method described above may be modified to detect other meteorological phenomena, including jet streams. Jet streams are fast flowing, meandering air currents in the Earth's atmosphere located primarily near the tropopause. Due to jet streams tending to combine, split, change direction, and vary their properties in other ways, a highly accurate detection method is desired. To resolve the deficiencies of the aforementioned conventional methods, the exemplary embodiments of this application apply the principles of gradient descent to identify jet streams.

Polar jet streams typically range in speed from 80 to 140 miles per hour (mph), though some jet streams exceed 200 mph. Jet streams frequently have an elevation between 6 to 8 miles (9 to 13 kilometers) above sea level, but in extreme winter cases can be as low as 4 miles (6 kilometers) in altitude. Subtropical jet streams are strongest in the northern hemisphere winter, with speeds similar to polar jet streams but with a height closer to 8 miles (13 kilometers) above sea level. Thus, the particles (data points; values) used in the disclosed method typically have a wind speed of at least 80 mph and an elevation of at least 4 miles.

The method for detecting jet streams using gradient descent principles according to this embodiment may be understood with reference to the flowchart of FIG. 2.

First, the processor 2 acquires the data of the particles from a global forecast system (step S1). Here, the particles each have a wind velocity value and a wind direction value. For example, the data may be acquired as a grid of values across the entire Earth, or across a particular region of the Earth. For each data point (particle), there will be a wind velocity value and a wind direction value for each of three dimensions: x, y and z.

Next, in step S2, the acquired data is prepared for the gradient descent method by organizing the particles according to their position, thereby generating a distribution of particles for use in the method. The data is prepared for the gradient descent method by organizing the particles at regularly spaced intervals, thereby generating a distribution of particles for use in the method. As an example, the data points (particles) may be distributed across the grid with ¼ degree between each particle. At this step, all of the data points are used in the distribution, and no interpolation is required.

Also at step S2, the particle distribution (grid) is divided equally by a threshold region size (e.g., 1/10 grid) across the entire grid to define an escape condition. This will be described in greater detail below with respect to step S4.

Next, each particle is put through an iterative process using gradient descent principles to detect the wind velocity values within a threshold region as described below (step S3).

In step S31, for each particle a force (velocity) to be applied is calculated. As one example, a first particle has an initial position value, an initial wind velocity (property) value, and an initial wind direction value. Taking the four points surrounding the first particle in the distribution in each of the three dimensions (i.e., the eight points surrounding the first particle), the distance from each surrounding particle as well as the x, y and z-direction offsets from each surrounding particle are calculated. Using the hypotenuse of the triangle between the first particle and each surrounding particle, the x, y and z components are calculated and normalized (to be between 0 and 1). As shown in FIG. 2, an interpolation function is applied in step S31 to find the positions in the x, y and z-directions for each particle because not all of the particles will be on a grid point of the distribution data. The wind velocity of the first particle is then compared to the wind velocity of each surrounding particle, and the x, y and z components of the first particle are multiplied by the difference to obtain a vector of momentum. Unlike the above-described embodiment for finding pressure zones, in this embodiment only higher values (of wind velocity) are sought. This process is repeated with respect to all eight surrounding particles. The vectors of momentum with respect to all eight surrounding particles are added together to obtain a force to add to the first particle to cause the first particle to move toward a higher wind velocity value.

The force is then adjusted to take into consideration the wind direction of the particle. Specifically, a small amount of force is either added to or subtracted from the initially calculated force (velocity vector) depending respectively on whether the wind direction is same or opposite the direction of the initially calculated velocity vector. The wind direction is based on the “u” and “v” values of the particle. Each time the particle is moved to a new position using the iterative process, the particle will have new “u” and “v” values, and these “u” and “v” values provide a wind direction and velocity at that position. The wind direction at each iteration is used to bias the newly calculated velocity vector by adding or subtracting force. The amount of force added or subtracted (i.e., the wind direction bias) is determined based on the magnitude and direction of the wind at each position (u, v) of the particle. By using the wind direction as a bias, the jet stream identification of this disclosure is more accurate because it more closely tracks (follows) the actual jet stream wind movement. The vast majority of the force applied to the particle will be in the direction of higher wind speed, but a small amount will also be applied in the direction and magnitude of the wind itself.

As shown in FIG. 2, an interpolation function is then applied in step S31 to find a higher wind speed value that is located on a grid point within the distribution, and the first particle is moved toward that gridded higher wind velocity value using the velocity vector that has been calculated, and then taking into consideration the direction and speed of wind at that point in space.

As noted above, although this process identifies high wind velocity values by iteratively moving the particles toward higher values using gradient ascent principles, for the sake of simplicity this embodiment is described as using gradient descent principles.

In step S32, the calculated force is then added to the velocity vector of the first particle (Equation (1)). Initially, the particle will have no velocity vector because it will not be moving within the distribution. By adding this force to the particle, a velocity vector is created by which the particle moves toward the higher wind velocity data points. However, with subsequent iterations of step S3 of the disclosed method, this force will be newly calculated and added to the existing velocity vector.

In step S33, it is determined whether or not the sign of the velocity vector of the particle in question has changed (“flipped”) from positive to negative or from negative to positive; and, if the sign has flipped, the boundaries of a boundary region are set or updated at the position of the sign flip, as described above for the pressure zone identification embodiment. In this jet stream identification embodiment, if the force added to the particle is negative and the previous velocity vector of that particle was positive, or vice versa, this indicates that the sign of the velocity has flipped at the current position of the particle. This position then serves as a boundary position. The boundary region (i.e., the region defined by the boundary positions) is set and updated separately for each individual particle. Because, as discussed above, the initial value of the particle has no velocity, updating of the boundary position is only considered for second and subsequent iterations of step S3. Also, if the sign of the velocity of the particle has not flipped, the boundary is not updated.

In step S34, the velocity of the particle is added to the position (Equation (2)). In other words, after the velocity (force) is calculated, the position value of the particle is updated based on the position to which the particle moves due to the added velocity. As noted in the preceding paragraph, if the sign has flipped, this new position represents the updated boundary region.

Next, in step S35, each particle is tested to determine whether it meets an escape condition. Once the boundary positions of a particle are equal to or less than the predetermined distance that defines the threshold region, the escape condition is determined to be met for that particle. In this embodiment, the predetermined distance that defines the threshold region is set to be smaller than in the previous embodiment. For example, the threshold region could be 1/10 degree of the grid. In this case, if the boundary positions of the particle are separated by 1/10 degree or less, the particle is determined to have met the escape condition.

If the escape condition is determined to be met for a particular particle, step S3 ends for that particle, and the process bypasses step S36 and proceeds directly to step S4. If, on the other hand, the escape condition is determined not to be met for the particle, the process proceeds to step S36. In step S36, the velocity vector of the particle is multiplied by a scalar component of friction (Equation (3)). After step S36, the process returns to step S31 to repeat the iterative gradient descent loop. For each particle that does not meet the escape condition in step S35, the iterative gradient descent loop of steps S31 to S36 is repeated until all particles satisfy the escape condition, or until a maximum number of iterations has been performed.

Next, in step S4, the escaped particles (i.e., particles satisfying the escape condition) are collected and organized into a series of points representing the jet stream. As noted above, when the data is prepared in step S2, the particle distribution (grid) is divided equally by the threshold region size (e.g., 1/10 grid) to define the escape condition. Unlike in the preceding embodiment, in this embodiment there will not be any escape regions. Instead, the escaped particles will be post-processed based on their positions and the interpolated wind direction and speed at those positions to generate a set of point sequences (lines) that will define one or more jet streams. In addition, only the particles having the highest wind velocity and meeting the escape condition will be considered.

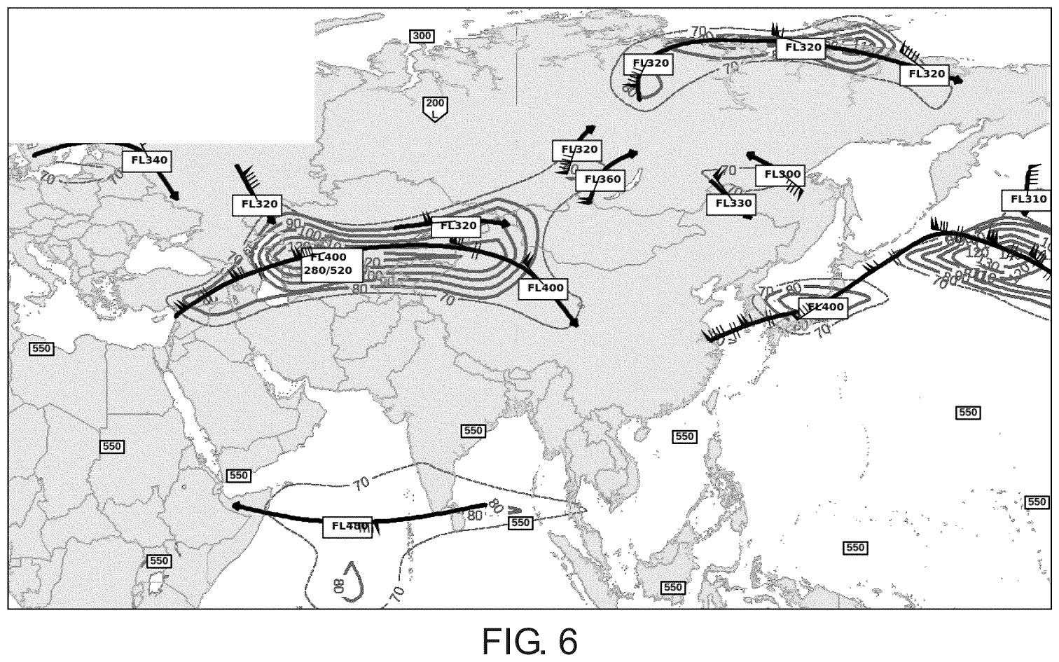

In this embodiment, step S5 is not executed. Instead, the process proceeds directly from step S4 to step S6. In step S6, the list of results is output. The processor 2 may output this list of results in a number of formats. The results may be output as formatted data sets. Alternatively, the results may also be output in a map format for display on the display 4. FIG. 6 shows an example of a map display depicting the identified jet streams. Each displayed jet stream is formed by connecting the wind velocity values from each escaped particle. The map may be colored to indicate the variations in wind speed, elevation, and other values for each jet stream.

With the meteorological event detection system and method of this embodiment, the processor 2 executes an iterative process using gradient descent principles. With this iterative process, the processor 2 more accurately detects and identifies jet streams as compared to conventional methods that did not use the principles of gradient descent. As discussed above, the disclosed system and method improve the processing accuracy in detecting jet streams. Specifically, conventional methods did not use gradient descent principles to iteratively determine higher wind velocity positions. Instead, conventional methods merely connected the extrema found in the acquired data set.

In addition, conventional methods failed to use the wind direction (u, v) as a bias when adjusting the position of data points. By using the wind direction as a bias, the jet stream identification of this disclosure is more accurate because it more closely tracks the actual jet stream wind movement and thus is truer to the actual physical phenomena. In this way, the disclosed system and method provide an improvement over conventional processors that were not able to apply gradient descent principles to iteratively arrive at more accurate detections of jet stream particles.

Moreover, the use of gradient descent principles in identifying the jet stream avoids the local disruption problem, where the jet stream may slow down locally but continue a few tens or hundreds of kilometers away. Manual forecasting and drawing can easily spot these conditions and draw the connection between them, whereas conventional automated methods often misinterpret the locally slowed position as the end of the local stream.

These improvements in accuracy lead to an additional improvement to the display of the jet streams. Specifically, because the jet streams are more accurately identified via gradient descent, the display of the jet streams on, for example, a map is improved. These improvements in detection and display of jet streams greatly impact the aviation and other industries that rely on accurate jet stream identification for safety and efficiency.

The disclosed method lends itself well to parallel processing with tools like OpenMP, OpenCL, or other parallel computing solutions. Although each iteration in step S3 is dependent on the last iteration, the particles themselves are not dependent on each other and can be processed simultaneously in each iteration. In other words, the disclosed method enables the processor to detect the meteorological event at a higher processing speed than in conventional methods because the disclosed method allows for all particles to be simultaneously processed in each iteration.

In addition, because the disclosed method avoids the use of complex “trig” functions which conventional methods relied upon, improved processing speeds can be achieved for the processor by the disclosed method. Note that “trig” functions in programming refer to any mathematical function that is not inherent in the ALU, for instance square root, pow( ), logarithm, sin, cos, tan, etc.

### (3) Other Applications

Although the exemplary embodiments are directed to the identification of jet streams and the detection of high and low pressure zones, the features of this disclosure can be applied to detect various other meteorological events. For example, the disclosed method including the iterative gradient descent process can be used to identify severe points of storms, tornado forming signatures, hurricane movement and a wide variety of other weather phenomena. The method can also be applied to improve the accuracy of radar imagery, to find the most significant data points for forming images.

It will be appreciated that the above-disclosed features and functions, or alternatives thereof, may be desirably combined into different systems and methods. Also, various alternatives, modifications, variations or improvements may be subsequently made by those skilled in the art, and are also intended to be encompassed by the disclosed embodiments. As such, various changes may be made without departing from the spirit and scope of this disclosure.

What is claimed is:

1. A meteorological event detection method comprising:
(a) providing a distribution of a plurality of data points based on meteorological data, each data point having at least (i) a geographical position, and (ii) a property value that relates to a meteorological condition, and each data point corresponding to a particle that has a first position corresponding to the geographical position and is moveable within the distribution;
(b) for each particle, assigning a velocity vector based on the property values of surrounding data points;
(c) for each particle, assigning an updated position to the particle based on the first position and the velocity vector;
(d) then for each particle, determining whether the particle satisfies an escape condition by determining whether movement of the particle is bounded within a space that satisfies the escape condition, wherein the escape condition is set based on a predetermined threshold spatial size within the distribution;
(e) determining a plurality of final property values, wherein each final property value relates to the meteorological condition and is determined based on the updated position of at least one particle that is determined to satisfy the escape condition; and
(f) detecting a meteorological event based on the plurality of the final property values.

2. The meteorological event detection method according to claim 1, further comprising:
defining a plurality of escape regions within the distribution, each escape region having the predetermined threshold spatial size;
grouping, into each of the plurality of escape regions, particles that satisfy the escape condition at the updated position that is within the corresponding escape region; and
determining the final property value for each escape region based on the particles that are grouped into the corresponding escape region.

3. The meteorological event detection method according to claim 2, further comprising
for each escape region, calculating an average position value based on the updated positions of the particles grouped in the corresponding escape region, wherein
the final property value for each escape region is determined based on the average position value.

4. The meteorological event detection method according to claim 2, further comprising
calculating a number of particles in each escape region; and
determining a significance of the final property value of each escape region based on the number of particles in each escape region.

5. The meteorological event detection method according to claim 4, wherein
the meteorological event is detected using only the final property values having a significance that is equal to or greater than a significance threshold.

6. The meteorological event detection method according to claim 1, further comprising
for each particle that is determined not to satisfy the escape condition, iteratively repeating steps (b), (c) and (d) until the escape condition is satisfied or until a predetermined number of such iterations has been performed.

7. The meteorological event detection method according to claim 1, wherein, in step (d), the movement of the particle is determined to be bounded within the space based on positions at which the velocity vector changes sign between positive and negative.

8. The meteorological event detection method according to claim 1, wherein
the escape condition is that the space bounding the movement of the particle is within the predetermined threshold spatial size.

9. The meteorological event detection method according to claim 1, further comprising
based on the detected meteorological event, generating formatted data for displaying a graphical representation of the meteorological event; and
outputting the formatted data.

10. The meteorological event detection method according to claim 9, further comprising
displaying the graphical representation of the meteorological event.

11. The meteorological event detection method according to claim 1, wherein
the detected meteorological event is a pressure zone or a jet stream.

12. An information processing apparatus for meteorological event detection comprising:
a memory storing data; and
a processor programmed to:
(a) provide a distribution of a plurality of data points based on meteorological data, each data point having at least (i) a geographical position, and (ii) a property value that relates to a meteorological condition, and each data point corresponding to a particle that has a first position corresponding to the geographical position and is moveable within the distribution;
(b) for each particle, assign a velocity vector based on the property values of surrounding data points;
(c) for each particle, assign an updated position to the particle based on the first position and the velocity vector;
(d) then for each particle, determine whether the particle satisfies an escape condition by determining whether movement of the particle is bounded within a space that satisfies the escape condition, wherein the escape condition is set based on a predetermined threshold spatial size within the distribution;
(e) determine a plurality of final property values, wherein each final property value relates to the meteorological condition and is determined based on the updated position of at least one particle that is determined to satisfy the escape condition; and
(f) detect a meteorological event based on the plurality of the final property values.

13. The information processing apparatus according to claim 12, wherein the processor is further programmed to
define a plurality of escape regions within the distribution, each escape region having the predetermined threshold spatial size;
group, into each of the plurality of escape regions, particles that satisfy the escape condition at the updated position that is within the corresponding escape region; and
determine the final property value for each escape region based on the particles that are grouped into the corresponding escape region.

14. The information processing apparatus according to claim 13, wherein the processor is further programmed to
for each escape region, calculate an average position value based on the updated positions of the particles grouped in the corresponding escape region, wherein
the final property value for each escape region is determined based on the average position value.

15. The information processing apparatus according to claim 13, wherein the processor is further programmed to
calculate a number of particles in each escape region; and
determine a significance of the final property value of each escape region based on the number of particles in each escape region.

16. The information processing apparatus according to claim 15, wherein
the meteorological event is detected using only the final property values having a significance that is equal to or greater than a significance threshold.

17. The information processing apparatus according to claim 12, wherein the processor is further programmed to
for each particle that is determined not to satisfy the escape condition, iteratively repeat (b), (c) and (d) until the escape condition is satisfied or until a predetermined number of such iterations has been performed.

18. The information processing apparatus according to claim 12, wherein, in (d), the movement of the particle is determined to be bounded within the space based on positions at which the velocity vector changes sign between positive and negative.

19. The information processing apparatus according to claim 12, wherein
the escape condition is that the space bounding the movement of the particle is within the predetermined threshold spatial size.

20. The information processing apparatus according to claim 12, wherein the processor is further programmed to
based on the detected meteorological event, generate formatted data for displaying a graphical representation of the meteorological event; and
output the formatted data.

21. The information processing apparatus according to claim 20, wherein the processor is further programmed to
display the graphical representation of the meteorological event.

22. The information processing apparatus according to claim 12, wherein
the detected meteorological event is a pressure zone or a jet stream.
